(19) United States
(12) Patent Application Publication
(10) Pub. No.: US 2002/0127532 A1
(43) Pub. Date: Sep. 12, 2002

(54) Server and method for providing information created by means of tool by information producer to information requestor

(75) Inventor: Takahisa Eimori, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 09/947,359

(22) Filed: Sep. 7, 2001

(30) Foreign Application Priority Data
Mar. 8, 2001 (JP) 2001-065221(P)

(51) Int. Cl. G09B 3/00

(52) U.S. Cl. 434/350

(57) ABSTRACT

A server employed in an online educational system includes a circuit for transmitting a tool for producing lecture data and transmitting advertising data in response to a request from a lecturer computer, a circuit for receiving and storing the lecture data including the advertising data from the lecturer computer, a circuit for transmitting the lecture data including the advertising data to a student computer in response to a request from the student computer, a circuit for calculating an advertising rate to be collected from advertisers according to a state of employment of tools, and a circuit for calculating a fee to be distributed among lecturers according to the calculated advertising rate and the number of lecture data received by students.

### BACKGROUND OF THE INVENTION

1. Field of the Invention

The present invention relates to a server used for an online educational system by which lecture data is supplied from a lecturer to those who take or “attend” the lecture (herein referred to as “student(s)” for convenience of explanation). In particular, the invention relates to a server used for a system by which a lecturer can easily produce lecture data and students are not required to bear a lecture expense.

2. Description of the Background Art

Networks including the Internet that are now widespread are used for online education. Under one online educational system, a student who is going to take a lecture purchases a coupon necessary for receiving the lecture. The student pays a coupon for receiving a necessary lecture online. The student downloads lecture data stored in a server of the online educational system or receives lecture data broadcast via the Internet.

Such an online educational system allows a student to dispense with the labor of actually attending at a location where the lecture is held. Therefore, the student can receive necessary lecture data selected from numerous lectures prepared in the server without locational and time constraints.

On the one hand, the online educational system is advantageous in that it lessens the labor of students. On the other hand, the system has a disadvantage because a lecturer cannot directly use lecture data which the lecturer has been used in conventional lectures. Then, the lecturer has to produce lecture data for online teaching based on conventional lecture data. The lecturer creates the lecture data by means of creation tool or edit tool implemented by a computer. There are a considerable number of such tools sold by software manufactures.

It is difficult for the lecturer to select an appropriate one from the numerous tools. Lecturers are thus reluctant to create lecture data for online teaching. Consequently, the server of the online educational system cannot store a great number of lecture data. In addition, this online educational system requires students to pay for a lecture.

### SUMMARY OF THE INVENTION

One object of the present invention is to provide an information providing server and an information providing method by the server for enabling a lecturer to easily produce lecture data used for an online educational system or the like.

Another object of the present invention is to provide an information providing server and an information providing method by the server for eliminating the need for payment of lecture fee by those who take a lecture in an online educational system or the like.

Still another object of the present invention is to provide an information providing server and an information providing method by the server for enabling a lecturer to easily select a tool for producing lecture data used for an online educational system or the like.

A further object of the present invention is to provide an information providing server and an information providing method used by the server for making it possible to collect a considerable amount of fee to be paid to lecturers of an online educational system or the like from those except for students.

A still further object of the present invention is to provide an information providing server and an information providing method by the server for enabling numerous lecture data for an online educational system or the like to be collected.

According to one aspect of the present invention, an information providing server provides information via a network connected to a computer of an information producer and a computer of an information requester. The computer of the information producer transmits, to the server, information produced by the information producer by means of a tool implemented in the computer of the information producer. The server includes a receiving circuit connected to the network for receiving, from the computer of the information producer, the information produced by means of the tool, a storing circuit connected to the receiving circuit for storing the information received by the receiving circuit, a request receiving circuit connected to the network for receiving, from the computer of the information requester, a request for the information, a transmitting circuit connected to the storing circuit and the request receiving circuit for transmitting, to the computer of the information requester, in response to reception of the request from the computer of the information requester, the information stored in the storing circuit and advertising information for outputting on the computer of the information requester an advertisement of an advertiser of the tool used for producing the information, and a calculating circuit for calculating an advertising rate to be collected from the advertiser based on the number of information producers using the tool and calculating an information providing fee to be paid to the information producer based on the calculated advertising rate and the number of information requesters requesting reception of the information.

The information producer can create the information by means of the tool. The computer of the information requester outputs the advertisement based on the received advertising information. The advertisement is sponsored by the advertiser of the tool used for creating the information by the information producer. The server collects the advertising rate from the advertiser. The information producer receives the advertising rate from the server instead of a fee to be paid by students who receive the information (lecture). Accordingly, a lecturer, i.e., information producer, can easily produce lecture data and no lecture fee is charged to students, i.e., information requesters.

Preferably, the server further includes a demonstration storing circuit for storing tool demonstration information used for performing a demonstration of the tool in the computer of the information producer, a demonstration request receiving circuit for receiving a request for the demonstration from the information producer, and a demonstration transmitting circuit connected to the demonstration storing circuit and the demonstration request receiving circuit for transmitting the tool demonstration information to the computer of the information producer in response to reception of the request for the demonstration from the information producer.

The computer of the information producer outputs the demonstration of the tool based on the tool demonstration information. Then, the information producer can know contents of the tool and easily select any tool appropriate for information to be created by the producer.

More preferably, the server further includes a tool storing circuit for storing tool implementation information used for implementing the tool in the computer of the information producer, a tool request receiving circuit for receiving a request for the tool from the computer of the information producer, and a tool transmitting circuit connected to the tool storing circuit and the tool request receiving circuit for transmitting the tool implementation information to the computer of the information producer in response to reception of the request for the tool from the computer of the information producer.

In response to the request for the tool from the information producer, the server transmits the tool implementation information to the computer of the information producer. In the computer of the information producer, a text edit tool, a spreadsheet tool, a graphic tool and the like are implemented that are used for producing the information. The information producer can thus create the information easily.

More preferably, the request for the tool is made in two types, one is a request for a temporary use of the tool and the other is a request for a permanent use of the tool. The calculating circuit includes a circuit for calculating the advertising rate differing depending on whether the request is for a temporary use of the tool or for a permanent use of the tool.

The advertising rate, which is calculated by the server for collecting the rate from the advertiser, differs depending on whether the request is for a temporary use (trial) of the tool or for a permanent use (purchase) of the tool. In this way, the server can collect a higher advertising rate when the information producer purchases the tool than an advertising rate collected when the information producer uses the tool as trial.

Preferably, the transmitting circuit includes a circuit for transmitting to the computer of the information requester the advertising information having contents differing depending on whether the request is for a temporary use of the tool or for a permanent use of the tool.

The server provides the advertising information which differs depending on whether the request is for a temporary use (trial) of the tool or for a permanent use (purchase) of the tool. Then, an advertisement transmitted from the server to the information requester when the information producer will use the tool for a long period of time (i.e., the producer purchases the tool) can be made different from an advertisement transmitted when the information producer will use the tool for a short period of time (i.e., the producer uses the tool as trial). Regarding the trial use, the advertising information may not be transmitted to the information requester.

Preferably, the server further includes a requesting circuit for requesting that a computer of an information producer having transmitted a request for the tool and transmitted no information produced by the information producer by means of the tool should transmit information produced by means of the tool.

When any information producer has transmitted a request for the tool while the producer has not created or transmitted information, the server can request that information producer to transmit information. Accordingly, the server can store a considerable amount of information created by information producers.

According to another aspect of the present invention, an information providing method is employed by a server for providing information via a network connected to a computer of an information producer and a computer of an information requester. The computer of the information producer transmits to the server information produced by the information producer by means of a tool implemented in the computer of the information producer. The information providing method includes the steps of receiving, from the computer of the information producer, the information produced by means of the tool, storing the information received in the information receiving step, receiving a request for the information from the computer of the information requester, transmitting, to the computer of the information requester, in response to reception of the request from the computer of the information requester, the information stored in the storing step and advertising information for outputting at the computer of the information requester an advertisement of an advertiser of the tool used for producing the information, and calculating an advertising rate to be collected from the advertiser based on the number of information producers using the tool and calculating an information providing fee to be paid to the information producer based on the calculated advertising rate and the number of information requesters requesting the information.

The information producer can create the information by means of the tool. The computer of the information requester outputs the advertisement based on the received advertising information. The advertisement is sponsored by the advertiser of the tool used for creating the information by the information producer. By this information providing method, the advertising rate is collected from the advertiser. According to the information providing method, information producer receives the advertising rate instead of a fee to be paid by students who receive the information lecture). Then, a lecturer, i.e., information producer, can easily produce lecture data and no lecture fee is charged to students, i.e., information requesters.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an entire structure of an online educational system according to one embodiment of the present invention.

FIG. 2 externally shows a computer implementing a server.

FIG. 3 is a control block diagram of the computer.

FIG. 4 shows an advertiser database stored in a fixed disk.

FIG. 5 shows a user database stored in the fixed disk

FIG. 6 shows a charge database stored in the fixed disk.

FIG. 7 shows a fee database stored in the fixed disk.

FIG. 8 shows advertiser registration request data transmitted from an advertiser computer to the server.

FIG. 9 shows advertiser registration completion data transmitted from the server to the advertiser computer.

FIG. 10 shows lecturer registration request data transmitted from a lecturer computer to the server.

FIG. 11 shows lecturer registration completion data transmitted from the server to the lecturer computer.

FIG. 12 shows tool purchase request data transmitted from the lecturer computer to the server.

FIG. 13 shows tool trial request data transmitted from the lecturer computer to the server.

FIG. 14 shows purchase tool transmission data transmitted from the server to the lecturer computer.

FIG. 15 shows trial tool transmission data transmitted from the server to the lecturer computer.

FIG. 16 shows coupon notification data transmitted from the server to the lecturer computer.

FIG. 17 shows tool question data transmitted from the lecturer computer to the server.

FIG. 18 shows additional coupon notification data transmitted from the server to the lecturer computer.

FIG. 19 shows lecture data registration request data transmitted from the lecturer computer to the server.

FIG. 20 shows lecture request data transmitted from a student computer to the server.

FIG. 21 shows transmission data sent from the server to the student computer.

FIG. 22 shows charge notification data transmitted from the server to the advertiser computer.

FIG. 23 shows fee notification data transmitted from the server to the lecturer computer.

FIG. 24 is a flowchart showing an advertiser registration process executed by the server according to the embodiment of the present invention.

FIG. 25 is a flowchart showing a lecturer registration process executed by the server according to the embodiment of the present invention.

FIG. 26 is a flowchart showing a tool request process executed by the server according to the embodiment of the present invention.

FIG. 27 is a flowchart showing a tool question process executed by the server according to the embodiment of the present invention.

FIG. 28 is a flowchart showing an additional coupon notification process executed by the server according to the embodiment of the present invention.

FIG. 29 is a flowchart showing a lecture data reception process executed by the server according to the embodiment of the present invention.

FIG. 30 is a flowchart showing a lecture data transmission process executed by the server according to the embodiment of the present invention.

FIG. 31 is a flowchart showing a lecture analysis process executed by the server according to the embodiment of the present invention.

FIG. 32 is a flowchart showing a charging process executed by the server according to the embodiment of the present invention.

FIG. 33 is a flowchart showing a fee notification process executed by the server according to the embodiment of the present invention.

FIG. 34 shows demo request data transmitted from the lecturer computer to the server.

FIG. 35 shows demo transmission data transmitted from the server to the lecturer computer.

FIG. 36 is a flowchart showing a demo data transmission process executed by the server according to the embodiment of the present invention.

### DESCRIPTION OF THE PREFERRED EMBODIMENTS

Embodiments of the present invention are hereinafter described in conjunction with the drawings. In the following description and drawings, the same components are denoted by the same reference character and those components have the same designation and functionality. Therefore, those are not repeatedly described in detail.

<First Embodiment>

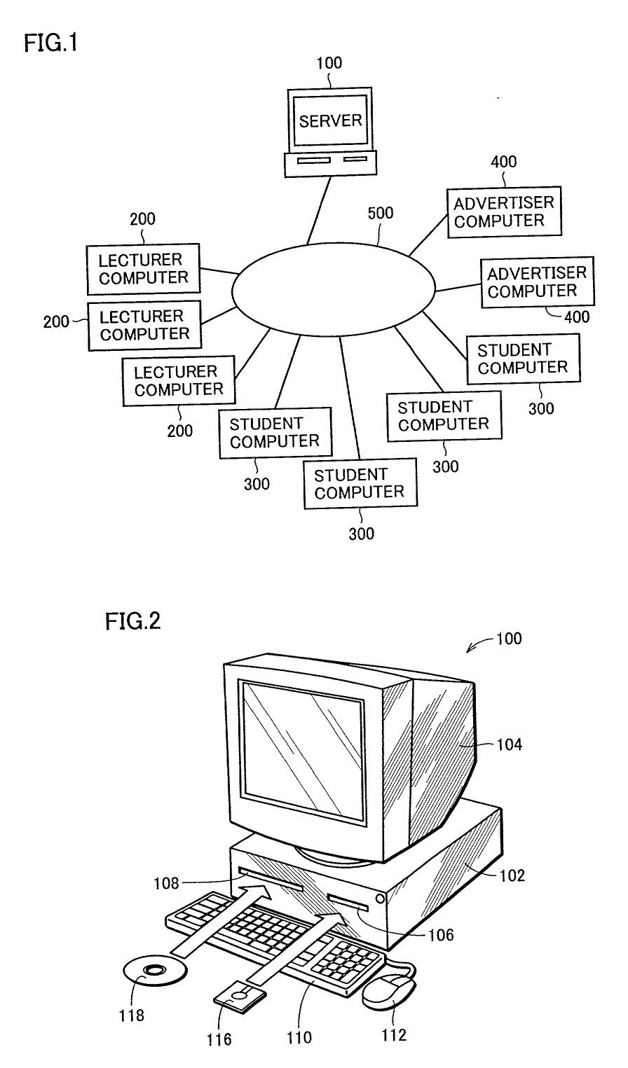

Referring to FIG. 1, an online educational system according to a first embodiment includes a lecturer computer 200 used by a lecturer, a student computer 300 used by a student (user who takes a lecture), an advertiser computer 400 used by an advertiser sponsoring a tool, and a server 100 connected to these computers via a network 500. The lecturer uses any tool for producing and editing text data or graphic data to create lecture data. The tool is implemented by lecturer computer 200. The student receives the lecture data produced by the lecturer via network 500.

Server 100 transmits a tool execution file to lecturer computer 200 in response to a request from lecturer computer 200. Server 100 transmits advertisement data of the advertiser of the tool together with the tool execution file.

Server 100 stores the lecture data produced by the lecturer by means of the tool implemented by lecturer computer 200. The stored lecture data includes the advertisement data of the advertiser of the tool used for creating the lecture data.

In response to a request from student computer 300, server 100 transmits the lecture data to student computer 300. The transmitted lecture data includes the advertisement data. By the lecture data, a lecture is output onto a monitor of student computer 300. By the advertisement data, an advertisement of the advertiser is output onto a monitor of student computer 300. In this way, server 100 performs an information providing function to provide the lecture data to the student.

Server 100 calculates an advertising rate to be collected from the advertiser depending on the state in which the tool is used. Server 100 then subtracts, from the collected advertising rate, running costs of server 100 and the like. The server 100 calculates a fee to be paid to the lecturer based on the resultant amount after the subtraction and the number of requests for the lecture data. The student can thus receive the lecture for free.

The information providing function of server 100 in the online educational system of this embodiment is implemented in a computer by executing a predetermined program by means of a CPU (Central Processing Unit).

FIG. 2 is an external view of a computer system as an example of server 100 carrying out the information providing function. Referring to FIG. 2, the computer system includes a computer 102 having an FD (Flexible Disk) drive 106 and a CD-ROM (Compact Disk-Read Only Memory) drive 108, a monitor 104, a keyboard 110 and a mouse 112.

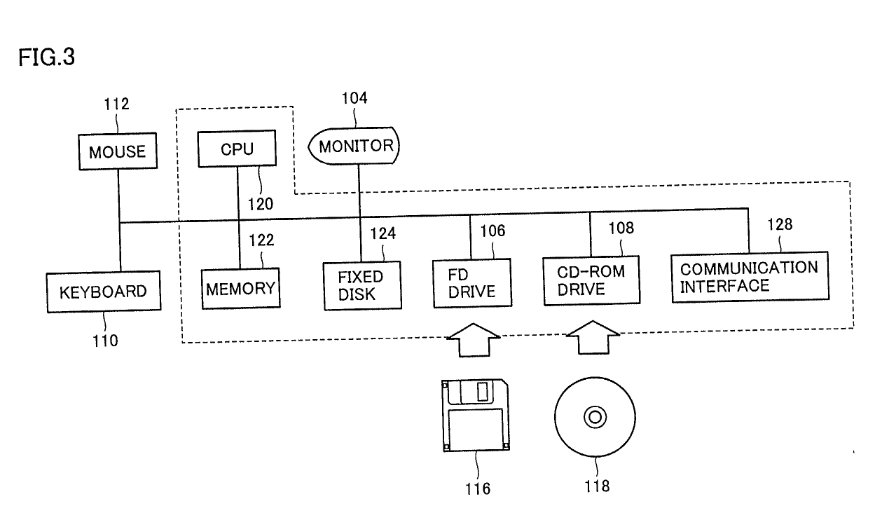

FIG. 3 shows in the form of block diagram a structure of the computer system. As shown in FIG. 3, computer 102 includes, in addition to FD drive 106 and CD-ROM drive 108 mentioned above, a CPU 120, a memory 122, a fixed disk 124 and a communication interface 128 for communication with other computers and these components are connected by a bus. An FD 116 is set in FD drive 106, and a CD-ROM 118 is set in CD-ROM drive 108. FD 116 and CD-ROM 118 store predetermined programs corresponding to software.

As discussed above, server 100 having the information providing function is implemented by computer hardware and software executed by CPU 120. In general, such software is distributed by being stored as a program in a recording medium like FD 116 and CD-ROM 118 and read from the recording medium by FD drive 106 or CD-ROM drive 108 to be stored temporarily in fixed disk 124. Further, the software is read from fixed disk 124 into memory 122 to be executed by CPU 120.

Hardware itself of the computer is typical one. The computer has a control circuit including the CPU, a memory circuit, an input circuit, an output circuit and an OS (Operating System) and accordingly has an environment for executing a program. According to the present invention, such a program is used to allow the computer to serve as an information providing device.

The operation of the computer shown in FIGS. 2 and 3 is well known and detailed description thereof is not given here.

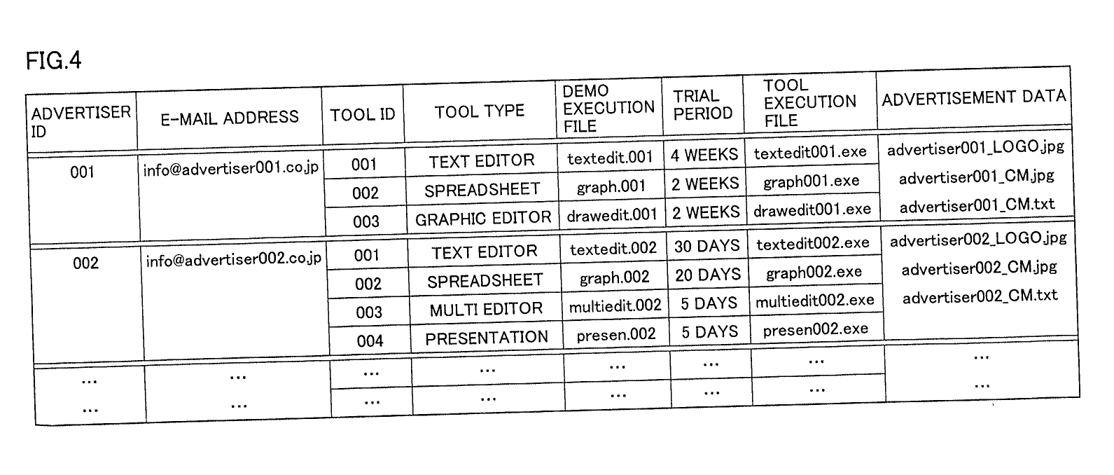

Referring to FIG. 4, fixed disk 124 of server 100 in this embodiment stores an advertiser database including, for each advertiser ID (Identification) for specifying an advertiser managed by server 100, an electronic mail address of the advertiser, a tool ID for specifying a tool managed by server 100, a tool type indicating the type of the tool, a name of a demo execution file for performing a demonstration of the tool, a tool trial period, a tool execution file name, and advertisement data.

The electronic mail address and the advertisement data are stored for each advertiser ID. The tool type, demo execution file name, trial period, and tool execution file name are stored for each tool ID. Server 100 can specify a tool managed in server 100 according to an advertiser ID and a tool ID.

Advertisement data are set per advertiser. The advertisement data includes “advertiser001_LOGO.jpg” representing a logo of the advertiser, “advertiser001_CM.jpg” representing advertising information of the advertiser by an image, “adertiser001_CM.txt” representing advertising information by text, and the like.

Referring to FIG. 5, fixed disk 124 of server 100 stores user database including, for each user ID for specifying a lecturer (user) managed by server 100, an electronic mail address of the user, field of a lecture of the user, years of experience of the lecturer, lecture data, the number of issued coupons, the number of purchased coupons, the number of remaining coupons, a used tool (advertiser ID/tool ID), and an advertiser ID having an advertising duty.

The tool can be used in either of two ways, i.e., by purchase or trial. In the case of purchase, the lecturer can use the tool for an indefinite period. In the case of trial, the lecturer can use the tool in the trial period shown in FIG. 4.

The number of issued coupons represents the number of coupons issued when the lecturer is registered from lecturer computer 200 into server 100. The purchased coupons are those coupons purchased by the user separately from the issued coupons. The number of remaining coupons is calculated by adding the number of purchased coupons to the number of issued coupons and then subtracting the number of used coupons from the sum. Every time a tool purchase request, a tool trial request or a tool question request is made, a predetermined number is subtracted from the number of remaining coupons.

The advertiser ID having an advertising duty is described. A user specified by the user ID “user001” purchases, as a first tool which the user employs (hereinafter referred to simply as first tool), a tool specified by the advertiser ID of “001” and the tool ID of “002”. When the tool is purchased, a duty is imposed on the advertiser of the tool to advertise. The user has a duty to include advertisement data of the advertiser specified by the advertiser ID of “001”.

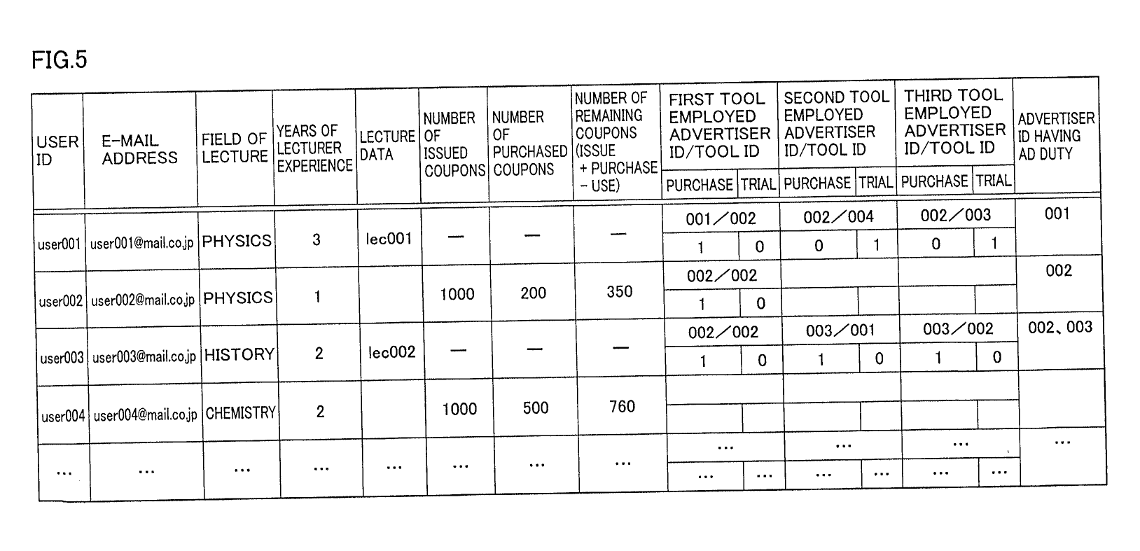

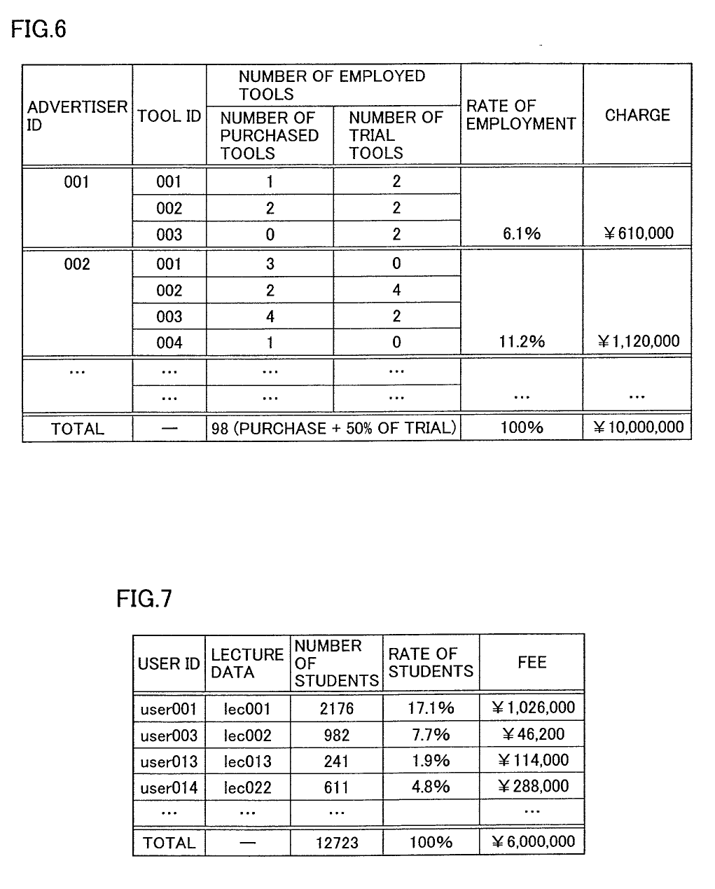

Referring to FIG. 6, fixed disk 124 of server 100 stores a charge database including, for each advertiser ID and each tool ID, the number of tools employed in lecturer computer 200, the rate of employment and a charge. The number of employed tools is calculated separately for each of purchased tools and trial tools. The total of employed tools is calculated by adding 50% of the number of trial tools to the number of purchased tools. Relative to the total of employed tools, the rate of employment is calculated per advertiser. The charge is calculated by multiplying the rate of employment by a predetermined amount. With regard to an advertiser specified by the advertiser ID of “001”, the rate of the total of employed tools (6) (purchased tools and trial tools) is 6.1% relative to the total number of employed tools (98). The calculated charge is accordingly 610 thousand yen which is 6.1% of the total of 10 million yen.

Referring to FIG. 7, fixed disk 124 of server 100 stores a fee database including, for each user ID, lecture data, the number of students, the rate of students and a fee. The total of fee is set at 60% of the total of the charge shown in FIG. 6. The residual 40% of the total of charge corresponds to cost for running server 100 by a manager of the server. The rate of students is calculated for each user. The rate of students represents the rate of students who receive lecture data produced by the user. The student rate is multiplied by the total fee to calculate a fee to be paid to the user. With regard to a user specified by the user ID “user001”, 2176 students out of the total 12,723 students take the lecture data of the user. As the student rate for this user is 17.1%, the calculated fee is 1 million and 26 thousand yen corresponding to 17.1% of 6 million yen.

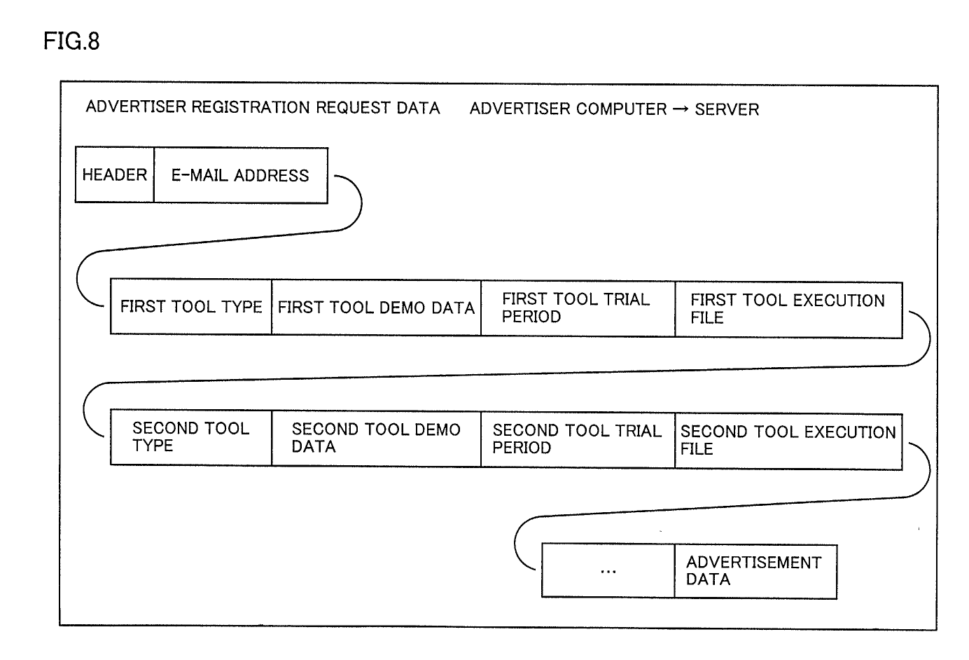

Referring to FIG. 8, advertiser computer 400 transmits to server 100 advertiser registration request data including a header, an electronic mail address, a first tool type, first tool demo data, a first tool trial period, a first tool execution file, a second tool type, second tool demo data, a second tool trial period, a second tool execution file, and advertisement data. Server 100 receiving this advertiser registration request data stores the data in the advertiser database (FIG. 4) in fixed disk 124.

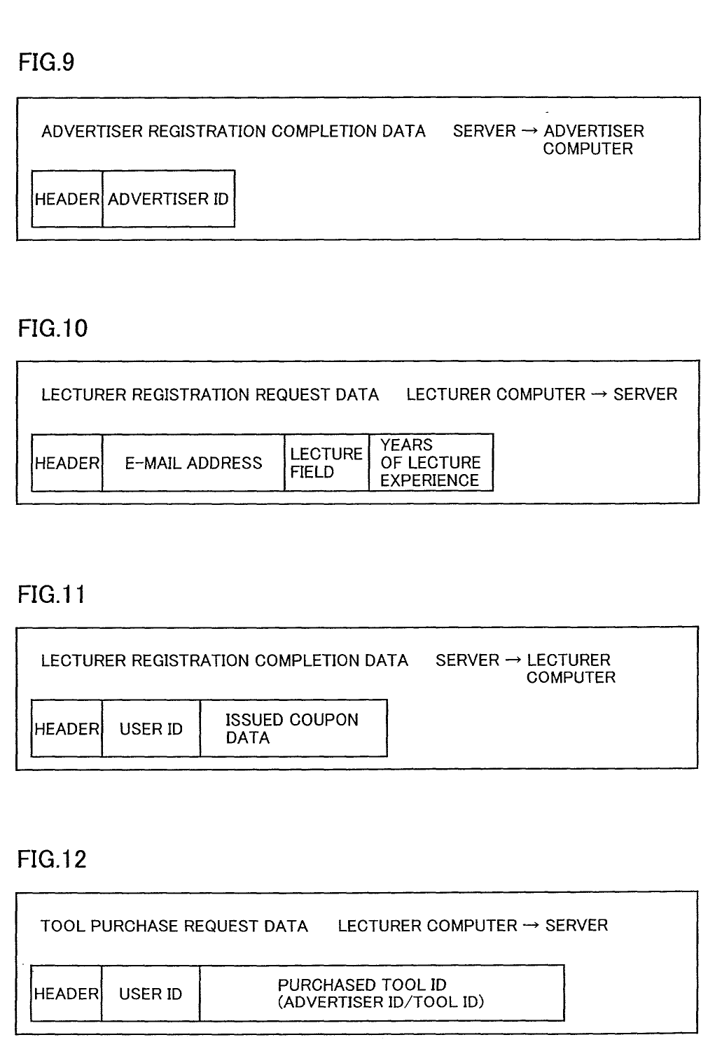

Referring to FIG. 9, server 100 transmits to advertiser computer 400 data indicating that registration of the advertiser has been completed (advertiser registration completion data). As shown in FIG. 9, the advertiser registration completion data includes a header and an advertiser ID. The advertiser ID is an identification code attached by server 100 for identifying the advertiser managed by server 100.

Referring to FIG. 10, lecturer computer 200 transmits to server 100 lecturer registration request data including a header, an electronic mail address, a lecture field and years of lecture experience. Server 100 receives the lecturer registration request data from lecturer computer 200 to store the data in the user database (FIG. 5) in fixed disk 124.

Referring to FIG. 11, server 100 transmits to lecturer computer 200 lecturer registration completion data including a header, a user ID and issued coupon data. The user ID is an identification code attached by server 100 for specifying the lecturer managed by server 100. The issued coupon data indicates the number of coupons transmitted to lecturer computer 200 when registration of the lecturer is completed. The issued coupon data is transmitted once when the lecturer is registered. The lecturer is not required to pay for the coupons.

Referring to FIG. 12, lecturer computer 200 transmits to server 100 tool purchase request data including a header, a user ID and purchased tool ID (advertiser ID/tool ID). Server 100 receiving the tool purchase request data can specify a tool execution file and advertisement data based on the advertiser database (FIG. 4).

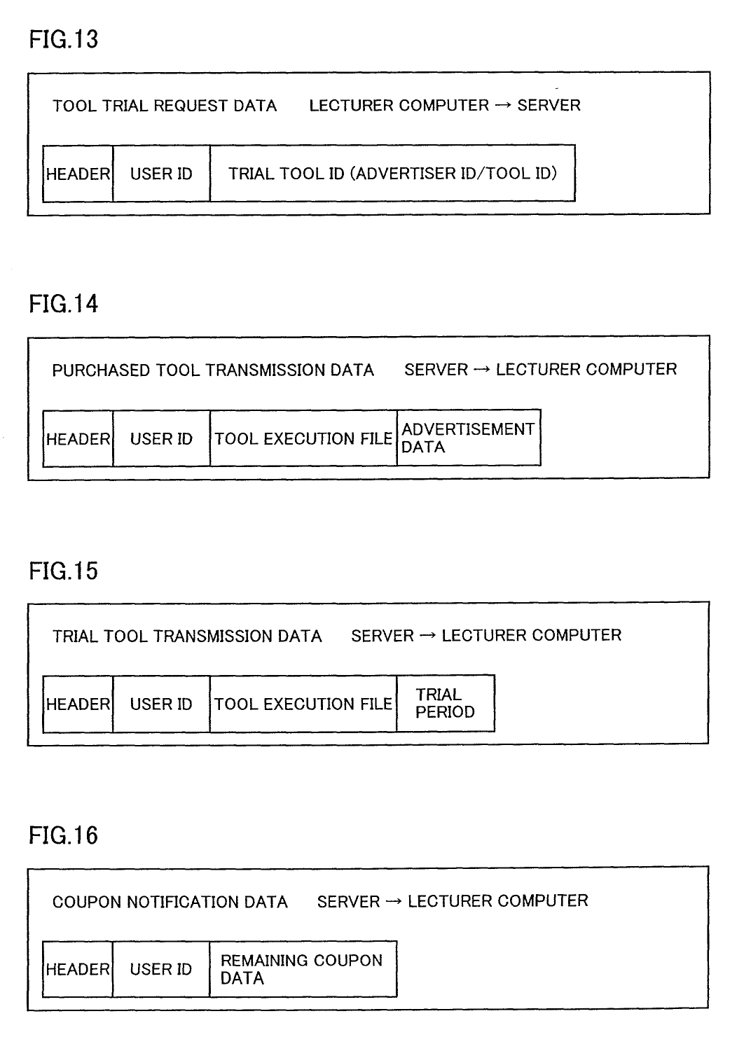

Referring to FIG. 13, lecturer computer 200 transmits to server 100 tool trial request data including a header, a user ID and a trial tool ID (advertiser ID/tool ID). Server 100 receiving the tool trial request data can specify a demo execution file and a trial period based on the advertiser database (FIG. 4).

Referring to FIG. 14, server 100 transmits to lecturer computer 200 purchased tool transmission data including a header, a user ID, a tool execution file and advertisement data. In response to the tool purchase request data shown in FIG. 12, server 100 transmits the purchased tool transmission data shown in FIG. 14 to lecturer computer 200.

Referring to FIG. 15, server 100 transmits to lecturer computer 200 trial tool transmission data including a header, a user ID, a tool execution file and a trial period. In response to the tool trial request data shown in FIG. 13, server 100 transmits the trial tool transmission data shown in FIG. 15 to lecturer computer 200. Lecturer computer 200 receiving the trial tool transmission data can execute the tool execution file only in the trial period.

Referring to FIG. 16, server 100 transmits to lecturer computer 200 coupon notification data including a header, a user ID and data indicating the number of remaining coupons. As described above, the number of remaining coupons is calculated by adding the number of purchased coupons to the number of issued coupons and subtracting the number of used coupons from the sum.

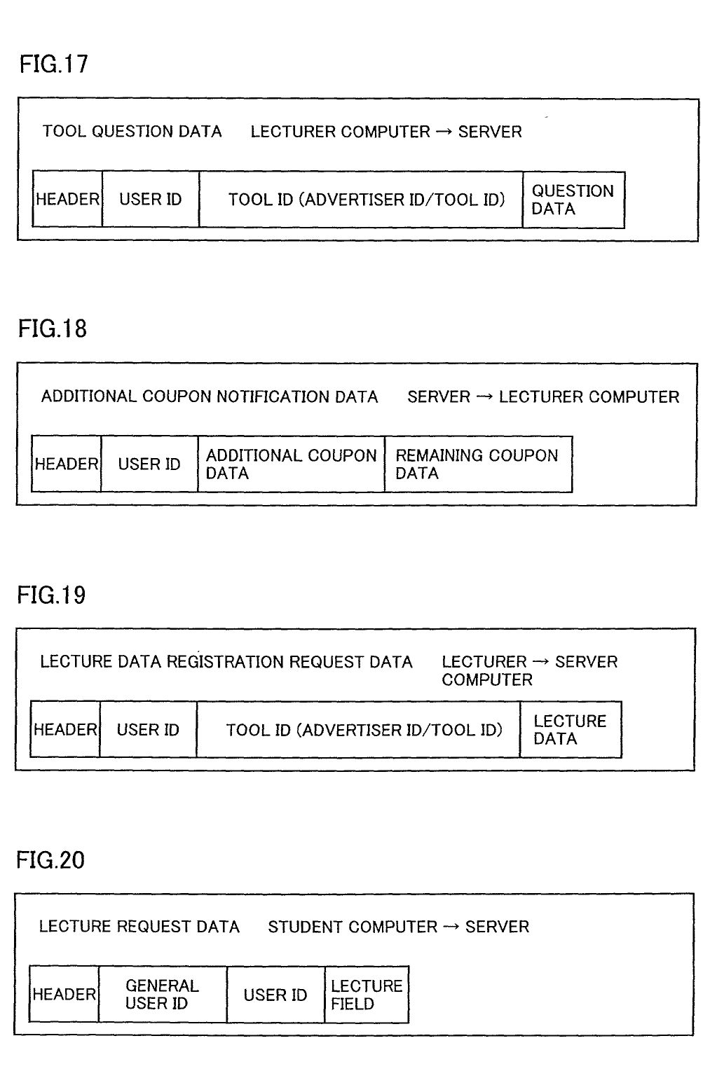

Referring to FIG. 17, lecturer computer 200 transmits to server 100 tool question data including a header, a user ID, a tool ID and question data.

Referring to FIG. 18, server 100 transmits to lecturer computer 200 additional coupon notification data including a header, a user ID, additional coupon data and remaining coupon data. The additional coupon notification data is transmitted from server 100 to lecturer computer 200 when the lecturer purchases additional coupons by means of an electronic settlement server connected to network 500. When the lecturer purchases additional coupons, the electronic settlement server transmits data indicating the number of additionally purchased coupons to server 100. Based on the data received from the electronic settlement server, server 100 transmits the additional coupon notification data to lecturer computer 200.

Referring to FIG. 19, lecturer computer 200 transmits to server 100 lecture data registration request data including a header, a user ID, a tool ID (advertiser ID/tool ID) and lecture data. If this lecture data is created by means of a purchased tool, the lecture data includes advertisement data placed with a predetermined frequency.

Referring to FIG. 20, student computer 300 transmits to server 100 lecture request data including a header, a general user ID, a user ID and a lecture field. The general user ID is an identification code attached by server 100 for specifying the student managed by server 100. Since a lecture registers one piece of lecture data in server 100, the lecture data can be specified by the user ID.

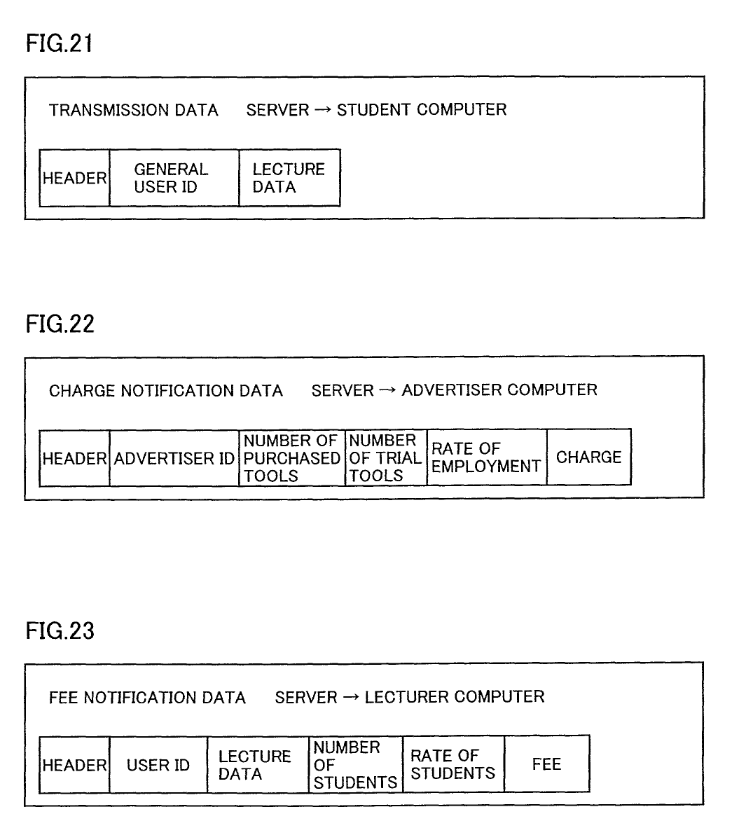

Referring to FIG. 21, server 100 transmits to student computer 300 transmission data including a header, a general user ID and lecture data. Student computer 300 receiving the transmission data displays contents of a lecture on a monitor of student computer 300 based on the lecture data. The student can “attend” the lecture by watching the monitor. If the lecture data includes advertisement data, an advertisement is displayed on the monitor of student computer 300 according to the advertisement data.

Referring to FIG. 22, server 100 transmits to advertiser computer 400 charge notification data including a header, an advertiser ID, the number of purchased tools, the number of trial tools, the rate of employment and a charge. The charge notification data is produced according to contents stored in the charge database shown in FIG. 6. The charge notification data is transmitted to each advertiser computer 400.

Referring to FIG. 23, server 100 transmits to lecturer computer 200 fee notification data including a header, a user ID, lecture data, the number of students, the rate of students and a fee. The fee notification data is produced according to data stored in the fee database shown in FIG. 7. The fee notification data is transmitted to each lecturer computer 200.

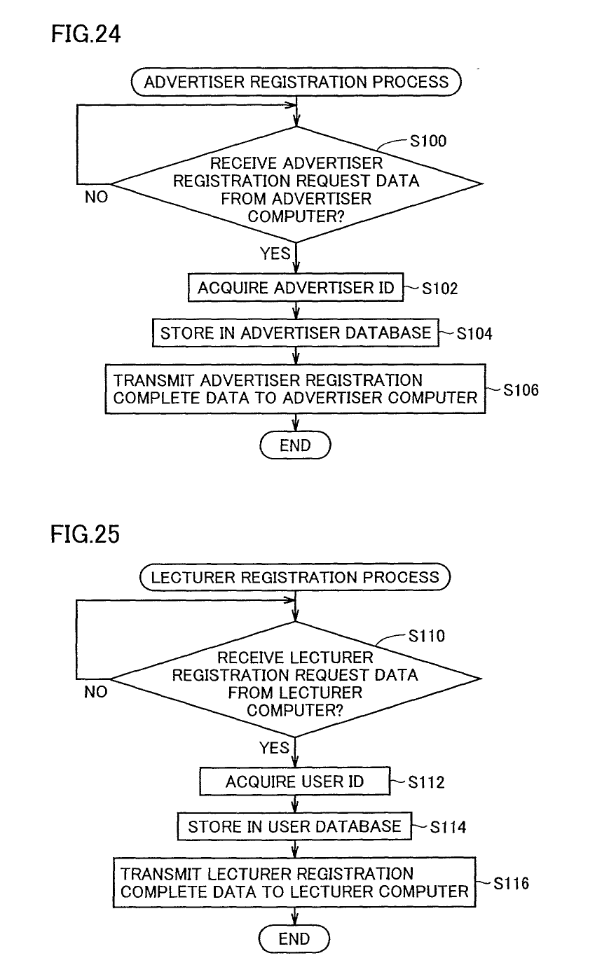

Referring to FIG. 24, server 100 executes a program regarding an advertiser registration process that has the following control structure.

In step (hereinafter abbreviated as S) 100, CPU 120 determines whether advertiser registration request data (FIG. 8) is received from advertiser computer 400. When the advertiser registration request data is received from advertiser computer 400 (YES in S100), the process goes to S102. If not (NO in S100), the process returns to S100 to wait for reception of advertiser registration request data from advertiser computer 400.

In S102, CPU 120 acquires an advertiser ID for specifying the advertiser managed by server 100. In S104, CPU 120 stores the data in the advertiser database (FIG. 4) in fixed disk 124 according to the advertiser registration request data and the advertiser ID.

In S106, CPU 120 transmits advertiser registration completion data (FIG. 9) to advertiser computer 400. The advertiser using advertiser computer 400 which receives the advertiser registration completion data thus knows that registration of the advertiser is completed.

Referring to FIG. 25, server 100 executes a program regarding a lecturer registration process that has the following control structure.

In S110, CPU 120 determines whether lecturer registration request data (FIG. 10) is received from lecturer computer 200. When the lecturer registration request data is received from lecturer computer 200 (YES in S110), the process goes to S112. If not (NO in S110), the process returns to S110 to wait for reception of lecturer registration request data from lecturer computer 200.

In S112, CPU 120 acquires a user ID for specifying the user managed by server 100. In S114, CPU 120 stores the data in the user database (FIG. 5) in fixed disk 124 according to the lecturer registration request data and the user ID. In S116, CPU 120 transmits lecturer registration completion data (FIG. 11) to lecturer computer 200. The lecturer using lecturer computer 200 which receives the lecturer registration completion data thus knows that registration of the lecturer is completed.

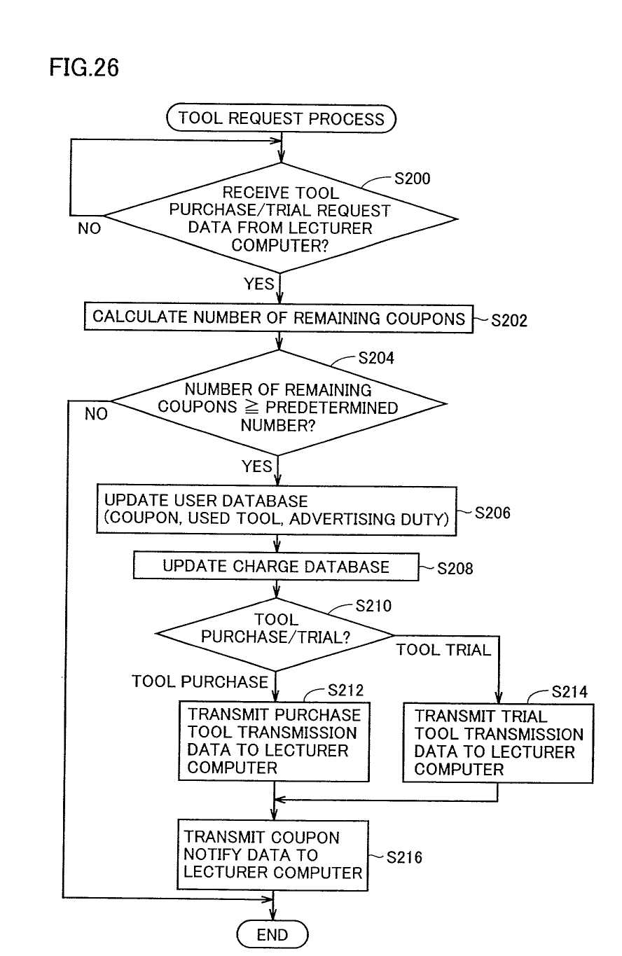

Referring to FIG. 26, server 100 executes a program regarding a tool request process that has the following control structure.

In S200, CPU 120 determines whether tool purchase request data (FIG. 12) or tool trial request data (FIG. 13) is received from lecturer computer 200. When the tool purchase request data or tool trial request data is received from lecturer computer 200 (YES in S200), the process goes to S202. If not (NO in S200), the process returns to S200 to wait for reception of tool purchase request data or tool trial request data from lecturer computer 200.

In S202, CPU 120 reads from the user database (FIG. 5) the number of remaining coupons of the user transmitting the tool purchase request data or tool trial request data. The number of remaining coupons is then calculated by subtracting from the current number of remaining coupons the number of coupons to be paid for purchase of a tool or for trial of a tool. At this time, the number of coupons to be subtracted is different depending on the purchase of a tool and the trial of a tool.

In S204, CPU 120 determines whether the resultant number of remaining coupons is equal to or greater than a predetermined number. If the number of remaining coupons is at least the predetermined number (YES in S204), the process goes to S206. If not (NO in S204), this tool request process is ended.

In S206, CPU 120 updates those items of the user database (FIG. 5), namely the number of remaining coupons, employed tool and advertiser ID having the duty of advertisement. In response to the tool purchase request data, an advertiser ID having the advertising duty is set. In S208, CPU 120 updates the charge database (FIG. 6).

In S210, CPU 120 determines whether requested details correspond to a tool purchase request or tool trial request. In the case of the tool purchase request (TOOL PURCHASE in S210), the process proceeds to S212. In the case of the tool trial request (TOOL TRIAL in S210), the process proceeds to S214.

In S212, CPU 120 transmits purchased tool transmission data (FIG. 14) to lecturer computer 200. In S214, CPU 120 transmits trial tool transmission data (FIG. 15) to lecturer computer 200.

In S216, CPU 120 transmits coupon notification data shown in FIG. 16 to lecturer computer 200.

In this way, each time a tool purchase request or tool trial request is made by lecturer computer 200, the number of remaining coupons is calculated. When the number of remaining coupons is at least a predetermined number, the purchased tool transmission data or trial tool transmission data is supplied to lecturer computer 200.

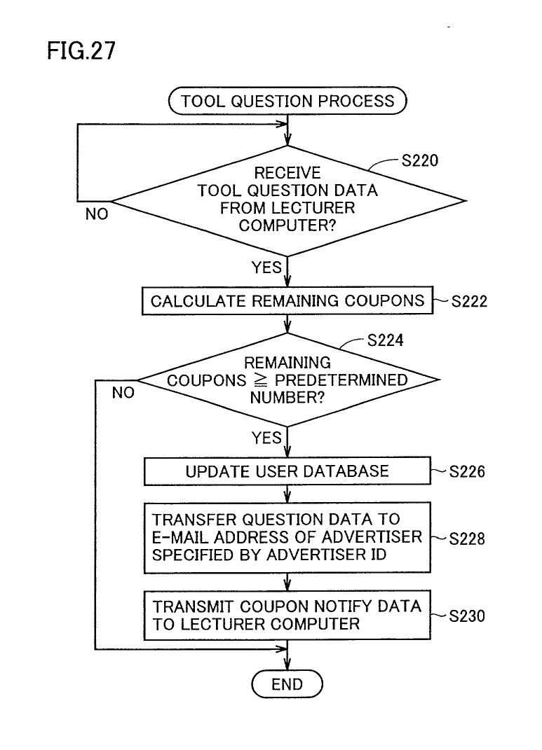

Referring to FIG. 27, server 100 executes a program regarding a tool question process that has the following control structure.

In S220, CPU 120 determines whether tool question data (FIG. 17) is received from lecturer computer 200. If the tool question data is received from lecturer computer 200 (YES in S220), the process goes to S222. If not (NO in S220), the process returns to S220 to wait for reception of tool question data from lecturer computer 200.

In S222, CPU 120 calculates the number of remaining coupons. The number of coupons to be paid for question about a tool is subtracted from the current number of remaining coupons. In S224, CPU 120 determines whether the number of remaining coupons determined in S222 is equal to or greater than a predetermined number. If the number of remaining coupons is at least the predetermined number (YES in S224), the process proceeds to S226. If not (NO in S224), this tool question process is ended.

In S226, CPU 120 updates the number of remaining coupons in the user database (FIG. 5). In S228, CPU 120 transfers question data included in the tool question data received in S220 to an advertiser specified by an advertiser ID. The advertiser has an address which is an electronic mail address stored in the advertiser database (FIG. 4). In S230, CPU 120 transmits coupon notification data (FIG. 16) to lecturer computer 200. The advertiser receiving the electronic mail transmits an answer to the question to the lecturer.

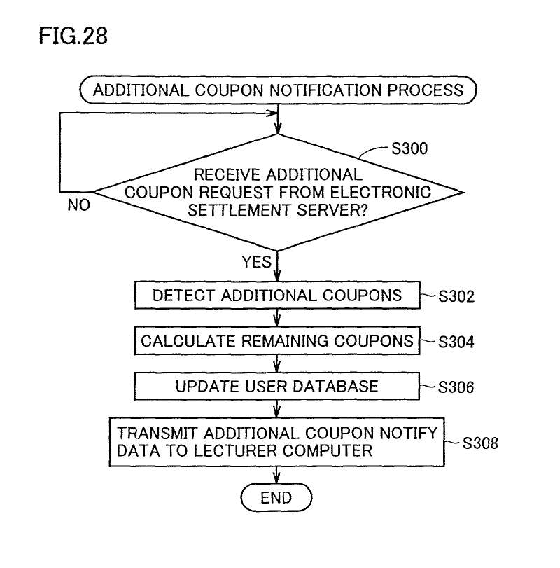

Referring to FIG. 28, server 100 executes a program regarding an additional coupon notification process that has the following control structure.

In S300, CPU 120 determines whether an additional coupon process request is received from the electronic settlement server connected to network 500. If the additional coupon process request is received from the electronic settlement server (YES in S300), the process goes to S302. If not (NO in S300), the process returns to S300 to wait for reception of an additional coupon process request from the electronic settlement server.

In S302, CPU 120 detects the number of coupons to be added according to data received from the electronic settlement server. In S304, CPU 120 calculates the number of remaining coupons including the coupons to be added. In S306, CPU 120 updates the number of purchased coupons and the number of remaining coupons in the user database (FIG. 5). In S308, CPU 120 transmits additional coupon notification data (FIG. 18) to lecturer computer 200.

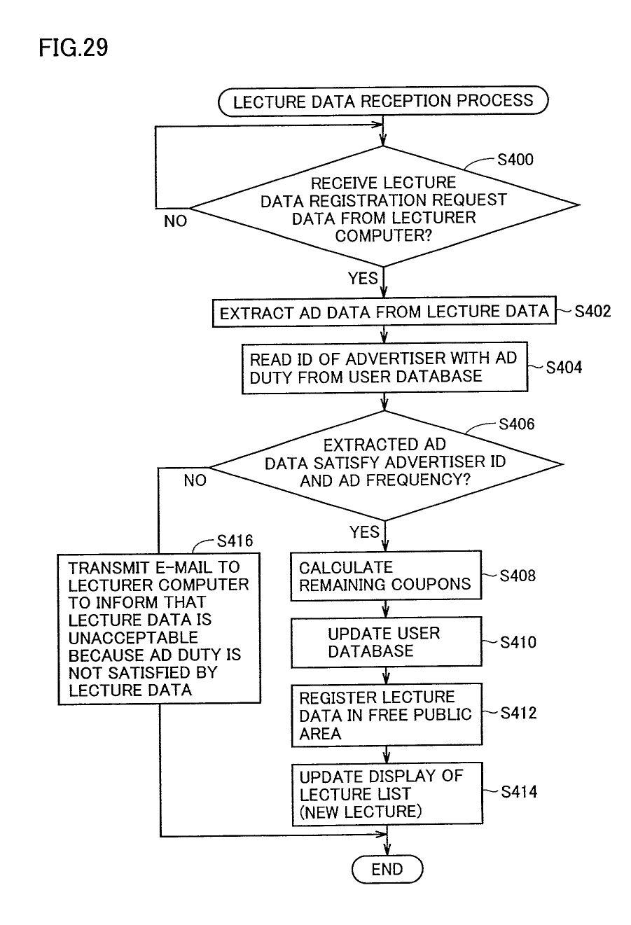

Referring to FIG. 29, server 100 executes a program regarding a lecture data reception process that has the following control structure.

In S400, CPU 120 determines whether lecture data registration request data (ig. 19) is received from lecturer computer 200. If the lecture data registration request data is received from lecturer computer 200 (YES in S400), the process goes to S402. If not (NO in S400), the process returns to S400 to wait for reception of lecture data registration request data from lecturer computer 200.

In S402, CPU 120 retrieves advertisement data included in the lecture data. In S404, CPU 120 reads from the user database (FIG. 5) an advertiser ID having an advertising duty associated with the user who has transmitted the lecture data registration request data.

In S406, CPU 120 determines whether or not the advertisement data retrieved in S402 meets the advertiser ID read in S404 and advertisement frequency. The advertisement frequency is a predetermined frequency with which an advertisement is to be included in the lecture data. The lecturer with its lecture data associated with the advertiser ID having the advertising duty must include the advertisement data within the lecture data to meet the advertisement frequency. If the retrieved advertisement data meets the advertiser ID and advertisement frequency (YES in S406), the process proceeds to S408. If not (NO in S406), the process proceeds to S416. If the lecture creates lecture data by means of a trial tool, no advertiser ID having an advertising duty is set and accordingly the determination in S406 is always YES.

In S408, CPU 120 calculates the number of remaining coupons. In S410, CPU 120 updates the user database (FIG. 5). In S412, CPU 120 registers the received lecture data in a free public area. In S414, CPU 120 updates display of a list of lectures (new lecture). General users know that a new lecture is registered in the free public area.

In S416, CPU 120 transmits an electronic mail to the effect that the lecture data cannot be accepted since the lecture data does not satisfy an advertising duty. Here, the destination address is an electronic mail address in the user database (FIG. 5).

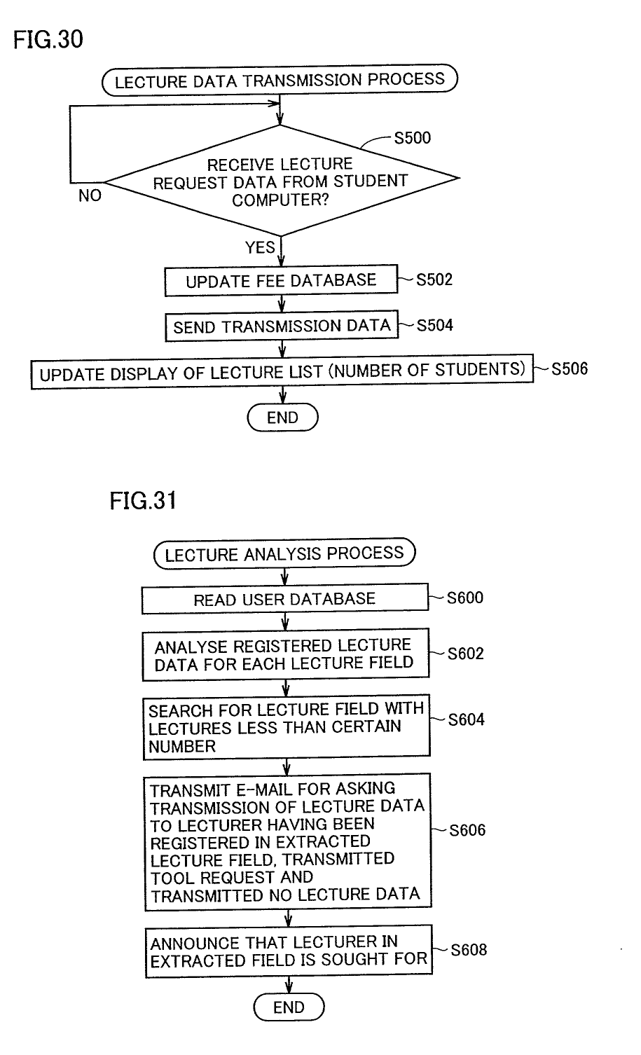

Referring to FIG. 30, server 100 executes a program regarding a lecture data transmission process that has the following control structure.

In S500, CPU 120 determines if lecture request data (FIG. 20) is received from student computer 300. If the lecture request data is received from student computer 300 (YES in S500), the process proceeds to S502. If not (NO in S500), the process returns to S500 to wait for reception of lecture request data from student computer 300.

In S502, CPU 120 updates the fee database (FIG. 7). In S504, CPU 120 sends transmission data (FIG. 21) to student computer 300 which has transmitted the lecture request data. In S506, CPU 120 updates display of a list of lectures (the number of students) and displays the updated list. General users can thus know the number of students for each lecture.

Referring to FIG. 31, server 100 executes a program regarding a lecture analysis process that has the following control structure.

In S600, CPU 120 reads the user database (FIG. 5). In S602, CPU 120 calculates the number of lecture data registered in the user database for each lecture field. In S604, CPU 120 searches for a lecture field for which the number of lecture data is equal to or smaller than a predetermined number.

In S606, CPU 120 searches for any lecturer who has been registered in the lecture field retrieved in S604, transmitted tool purchase request data or tool trial request data, and not transmitted lecture data yet. CPU 120 transmits an electronic mail to ask the retrieved lecturer to transmit lecture data. In S608, CPU 120 announces that any lecturer concerning the retrieved lecture field is sought for. Accordingly, concerning a field for which a relatively small number of lecture data are registered, a request for lecture data is transmitted to any lecturer who has not transmitted lecture data. Lecturers in the field are recruited.

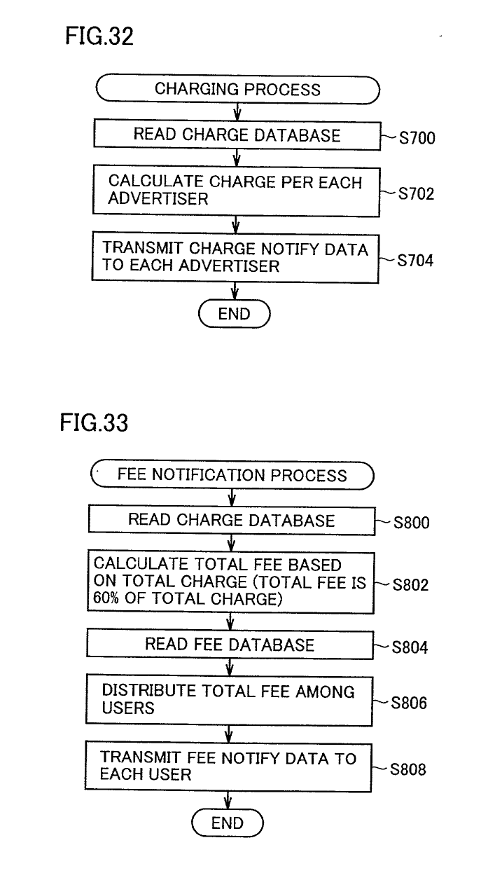

Referring to FIG. 32, server 100 executes a program regarding a charging process that has the following control structure.

In S700, CPU 120 reads the charge database (FIG. 6). In S702, CPU 120 calculates a charge for each advertiser. CPU 120 calculates the charge by multiplying the rate per advertiser determined according to the sum of the number of purchased tools and the number of trial tools by a predetermined amount. In S704, CPU 120 transmits charge notification data (FIG. 22) to each advertiser computer 400.

The advertiser receiving the advertiser charge data from server 100 pays the charge by means of the electronic settlement server. A manager of server 100 can thus collect the charge from the advertiser.

Referring to FIG. 33, server 100 executes a program regarding a fee notification process that has the following control structure.

In S800, CPU 120 reads the charge database (FIG. 6). In S802, CPU 120 calculates a total fee according to a total charge. The determined total fee is 60% of the total charge.

In S804, CPU 120 reads the fee database (FIG. 7). In S806, CPU 120 distributes the total fee among users. At this time, a fee for each user is determined according to the rate of students who take lecture data of that user (rate of students). In S808, CPU 120 transmits the fee notification data shown in FIG. 23 to each lecturer computer 200.

An operation of server 100 based on the structures and flowcharts detailed above is now described.

[Advertiser Registration]

An advertiser transmits advertiser registration request data (FIG. 8) from advertiser computer 400 to server 100. Server 100 receives the advertiser registration request data (YES in S100). Server 100 then acquires an advertiser ID (S102). Server 100 stores the data in the advertiser database shown in FIG. 4 (S104). Server 100 transmits advertiser registration completion data (FIG. 9) to the advertiser computer 400 which transmitted the advertiser registration request data (S106).

Through this operation, the data is stored in the advertiser database (FIG. 4) in fixed disk 124 of server 100.

[Lecturer Registration]

A lecturer uses lecturer computer 200 to transmit lecturer registration request data (FIG. 10) to server 100. Server 100 accordingly receives the lecturer registration request data (YES in S110). Server 100 then acquires a user ID (S112). Server 100 stores the data in the user database shown in FIG. 5 (S114). Server 100 transmits lecturer registration completion data (FIG. 11) to the lecturer computer 200 which transmitted the lecturer registration request data (S116). Through this operation, the data is stored in the user database (FIG. 5) in fixed disk 124 of server 100.

[Tool Request]

A lecturer transmits from lecturer computer 200 to server 100 purchase request data (FIG. 12) or trial request data (FIG. 13) for any tool that the lecturer desires to use. Server 100 then receives the data (YES S200). From the number of remaining coupons, the number of coupons to be paid for purchase of a tool or for trial of a tool is subtracted (S202). If the resultant number of remaining coupons is equal to or greater than a predetermined number (YES in S204), the user database (FIG. 5) and the charge database (FIG. 6) are updated (S206, S208).

When the tool purchase request is transmitted (TOOL PURCHASE in S210), server 100 transmits purchased tool transmission data (FIG. 14) to lecturer computer 200. Server 100 transmits to lecturer computer 200 a tool execution file as well as advertisement data.

When the tool trial request is transmitted (TOOL TRIAL in S210), server 100 transmits trial tool transmission data (FIG. 15) to lecturer computer 200. Server 100 transmits to lecturer computer 200 a tool execution file as well as data indicating a trial period.

The lecturer using the lecturer computer 200 which has received the purchased tool transmission data (FIG. 14) can use the tool for an indefinite period. An advertising duty is imposed when a tool is purchased. The lecturer is required to include in the lecture data the advertisement data at a predetermined frequency or higher. The lecturer using the lecturer computer 200 which has received the trial tool transmission data (FIG. 15) can use the tool for the trial period from the time when the trial tool transmission data is received.

[Questioning about Tool]

When a lecturer has a question about a tool, the lecturer transmits tool question data (FIG. 17) from lecturer computer 200 to server 100. Server 100 then receives the tool question data (YES in S220). Server 100 subtracts from the number of remaining coupons the number of coupons to be paid for question about the tool (S222). If the resultant number of remaining coupons is equal to or greater than a predetermined number (YES in S224), the number of remaining coupons in the user database (FIG. 5) is updated (S226). Server 100 transmits the question data to advertiser computer 400 (S228). Advertiser computer 400 receiving an electronic mail including the question data then makes an answer to the question to transmit the answer to lecturer computer 200. In this way, when the lecturer has a question about a tool, the lecturer can ask the question of the advertiser via server 100.

[Notification of Additional Coupons]

When a lecturer creating lecture data makes many tool purchase requests, many tool trial requests or many tool question requests, the number of remaining coupons decreases. At this time, the user (lecturer) purchases additional coupons by using the electronic settlement server connected to network 500. When the user purchases additional coupons, server 100 receives an additional coupon process request from the electronic settlement server (YES in S300). Server 100 then detects the number of coupons to be added (S302) and calculates the number of remaining coupons (S304). Server 100 accordingly updates the user database (FIG. 5) (S306). Server 100 transmits additional coupon notification data (FIG. 18) to lecturer computer 200 (S308). This operation allows a lecturer to purchase additional coupons when the number of remaining coupons becomes scarcer. Accordingly, the lecturer can further make a tool purchase request, a tool trial request and a tool question request.

[Lecture Data Reception]

When a lecturer produces lecture data, the lecturer transmits lecture data registration request data (FIG. 19) from lecturer computer 200 to server 100. Server 100 then receives the lecture data registration request data (YES in S400). Server 100 retrieves advertisement data from the received lecture data. Server 100 reads an advertiser ID having an advertising duty from the user database (FIG. 5). If the retrieved advertisement data meets the advertiser ID and advertisement frequency (YES in S406), the number of remaining coupons is calculated (S408). Server 100 updates the user database (FIG. 5) (S410). Server 100 registers the received lecture data in the free public area (S412). Server 100 updates display of a list of lectures (new lecture) for general users (S414).

By this operation, general users know that lecture data is newly registered in server 100 and can accordingly request the lecture data. Since the lecture data is registered in the free public area, students are not required to pay for the lecture.

[Lecture Data Transmission]

A student sends lecture request data (FIG. 20) from student computer 300 to server 100. Server 100 then receives the lecture request data (YES in S500). Server 100 updates the fee database (FIG. 7) (S502). Server 100 transmits transmission data (FIG. 21) to the student computer 300 which transmitted the lecture request data (S504). This operation enables the student to receive for free the lecture data registered in the free public area.

[Lecture Analysis]

Server 100 reads the user database (FIG. 5) at predetermined intervals (S600). Server 100 calculates the number of lecture data registered in the user database for each lecture field (S602). Then, a lecture field for which the number of lecture data is equal to or smaller than a predetermined number is searched for (S604). Server 100 searches for any lecturer who has been registered in the retrieved lecture field, has transmitted tool purchase or trial request data, and has not transmitted lecture data. Server 100 accordingly transmits an electronic mail to the retrieved lecturer to ask the lecturer to send lecture data (S606). Server 100 announces that lecturers in the retrieved field are sought for (S608). By this operation, it is possible to collect lecture data and lecturers in any lecture field for which lecture data is scarce and thus register a great number of lecture data.

[Charging]

Server 100 reads the charge database (FIG. 6) at predetermined intervals (S700). For example, the charge database is read at intervals of one month. According to the read charge database, server 100 calculates a charge for each advertiser (S702). Server 100 transmits the advertiser charge data (FIG. 22) to each advertiser (S704). Through this operation, an advertising rate for advertisement data included in lecture data can be collected from the advertiser.

[Fee Notification]

Server 100 reads the charge database (FIG. 6) at predetermined intervals (S800). For example, the charge database is read at intervals of one month. According to the total charge, server 100 calculates the total fee (S802). Server 100 reads the fee database (FIG. 7) (S804). According to the read fee database and calculated total fee, server 100 distributes the total fee among users (lecturers) to calculate a fee for each user (S806). According to the calculated fee, server 100 transmits fee notification data (FIG. 23) to each user. Through this operation, server 100 can distribute the total fee among lecturers depending on the number of students, the total fee determined by subtracting, from the advertising rate collected from advertisers, a cost for running server 100.

In this way, the server of this embodiment responds to a request from the lecturer computer to transmit a tool execution file and advertisement data. Then, the lecturer produces lecture data using a tool supplied from the server so that the advertisement data is included in the lecture data. The lecture data including the advertisement data is stored in the fixed disk of the server. In response to a request from the student computer, the server transmits lecture data to the student computer. The student computer outputs the received lecture data onto the monitor. Lecture contents and advertisement are displayed on the monitor. The server collects an advertising rate from advertisers as a charge for advertisement output to students. The collected advertising rate is distributed among lecturers producing lecture data. Accordingly, a server employed in an online educational system and the like can be provided by which lecturers can easily create lecture data using tools and students are not required to pay for lectures.

<Modification>

According to the first embodiment, server 100 stores a tool execution file and advertisement data. Server 100 transmits the tool execution file and advertisement data to lecturer computer 200 in response to tool purchase request data. An alternative operation according to a modification here is described below.

According to this modification, a computer which is not server 100 and is connected to network 500, advertiser computer 400 for example, stores a tool execution file and advertisement data. Lecturer computer 200 transmits tool purchase request data to this computer. The computer transmits the tool execution file and advertisement data to lecturer computer 200. A lecturer uses a tool implemented by the tool execution file supplied from the computer to produce lecture data including the advertisement data with a predetermined frequency. Lecturer computer 200 transmits the lecture data to server 100. Lecturer computer 200 transmits an advertiser ID and a tool ID for specifying the tool to server 100. Server 100 updates the advertiser ID having an advertising duty in the advertiser database and the charge database, according to the received advertiser ID and tool ID.

For the tool trial request, advertisement data is not included according to the first embodiment. However, contents of the advertisement data may be varied depending on the tool purchase request and the tool trial request. Alternatively, the frequency with which advertisement data is included in lecture data may be varied depending on the tool purchase request and the tool trial request.

Instead of the process in S606 of the first embodiment, a process may be employed by which a request for transmission of lecture data is made to a lecturer who has been registered in the retrieved lecture field and has not transmitted lecture data. Then, regardless of whether the lecturer has transmitted tool purchase and trial requests or not, a request for transmission of lecture data can be made.

In addition, although no response is made to tool purchase, trial and question requests when the number of remaining coupons is not at least a predetermined number in the first embodiment, server 100 may respond to a request from a lecturer regardless of the number of remaining coupons. After the response, server 100 may charge coupons to be paid for each request of a lecturer.

<Second Embodiment>

According to a second embodiment of the present invention, a server 100 uses different data for the tool request process from that of the first embodiment. According to the second embodiment, server 100 transmits tool demo data instead of the tool execution file. Other details are the same as those of the first embodiment. Therefore, description of the details is not repeated here.

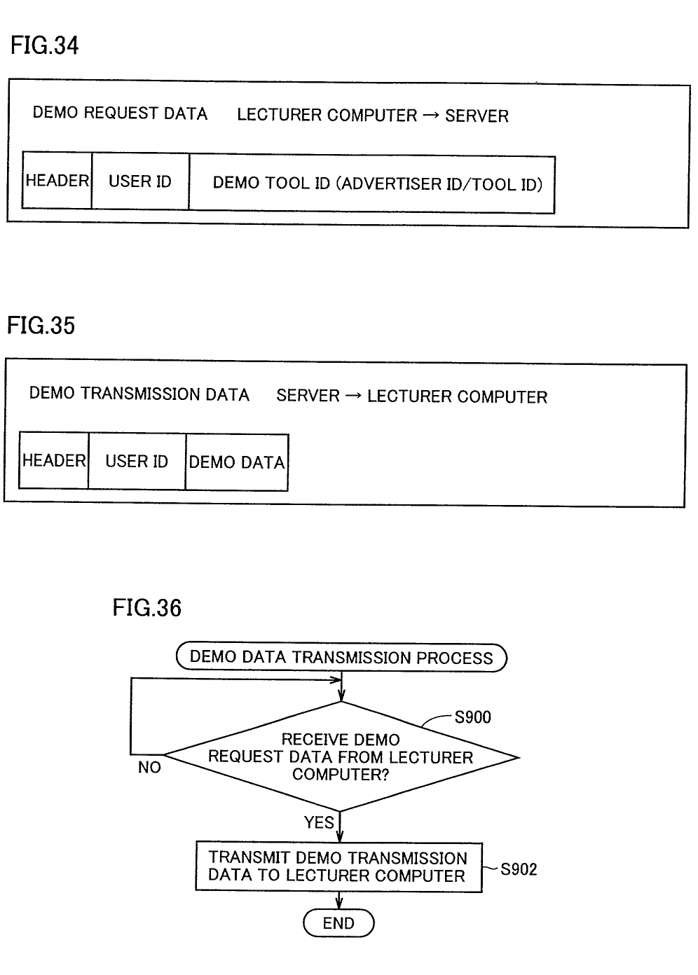

Referring to FIG. 34, a lecturer computer 200 transmits to a server 100 demo request data including a header, a user ID and a demo tool ID (advertiser ID/tool ID). Server 100 can specify a name of demo data for a tool requested by a lecturer according to the advertiser ID and tool ID.

Referring to FIG. 35, server 100 transmits to lecturer computer 200 demo transmission data including a header, a user ID and demo data. The demo data is specified by the demo data name registered in the advertiser database shown in FIG. 4.

Referring to FIG. 36, server 100 executes a program regarding a demo data transmission process that has a control structure as described below.

In S900, a CPU 120 determines whether or not demo request data (FIG. 34) is received from lecturer computer 200. If the demo request data is received from lecturer computer 200 (YES in S900), the process goes to S902. If not (NO in S900), the process returns to S900 to wait for reception of demo request data from lecturer computer 200. In S902, CPU 120 transmits demo transmission data (FIG. 35) to lecturer computer 200 which transmitted the demo request data.

The lecturer can receive the demo data from server 100 before the lecturer selects a tool implemented in lecturer computer 200. Lecturer computer 200 outputs demonstration of a tool onto a monitor according to the demo data. Then, the lecturer can select any tool based on the output demonstration.

The server of the second embodiment thus enables a lecturer to easily select any tool used for producing lecture data.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A server for providing information via a network connected to a computer of an information producer and a computer of an information requester, said computer of the information producer transmitting to said server information produced by said information producer by means of a tool implemented in said computer of the information producer,
said server comprising:
a receiving circuit connected to said network for receiving from said computer of the information producer said information produced by means of said tool;
a storing circuit connected to said receiving circuit for storing said information received by said receiving circuit;
a request receiving circuit connected to said network for receiving from said computer of the information requester a request for said information;
a transmitting circuit connected to said storing circuit and said request receiving circuit for transmitting to said computer of the information requester, in response to reception of said request from said computer of the information requester, the information stored in said storing circuit and advertising information for outputting on said computer of the information requester an advertisement of an advertiser of the tool used for producing said information; and
a calculating circuit for calculating an advertising rate to be collected from said advertiser based on the number of information producers using said tool and calculating an information providing fee to be paid to said information producer based on said calculated advertising rate and the number of information requesters requesting said information.

2. The server according to claim 1, further comprising:
a demonstration storing circuit for storing tool demonstration information used for performing a demonstration of said tool in said computer of the information producer;
a demonstration request receiving circuit for receiving a request for the demonstration from said information producer; and
a demonstration transmitting circuit connected to said demonstration storing circuit and said demonstration request receiving circuit for transmitting said tool demonstration information to said computer of the information producer in response to reception of said request for the demonstration from said information producer.

3. The server according to claim 1, wherein
said server is used in an online educational system for education via the network,
said information producer is a lecturer in said online educational system,
said information requester is a student in said online educational system, and
said information is lecture data.

4. The server according to claim 1, further comprising:
a tool storing circuit for storing tool implementation information used for implementing said tool in said computer of the information producer;
a tool request receiving circuit for receiving a request for said tool from said computer of the information producer; and
a tool transmitting circuit connected to said tool storing circuit and said tool request receiving circuit for transmitting said tool implementation information to said computer of the information producer in response to reception of said request for the tool from said computer of the information producer.

5. The server according to claim 4, wherein
said request for the tool is made in two types, one is a request for a temporary use of said tool and the other is a request for a permanent use of said tool, and
said calculating circuit includes a circuit for calculating said advertising rate differing depending on whether said request is for a temporary use of the tool or for a permanent use of the tool.

6. The server according to claim 4, wherein
said request for the tool is made in two types, one is a request for a temporary use of said tool and the other is a request for a permanent use of said tool, and
said transmitting circuit includes a circuit for transmitting to said computer of the information requester said advertising information having contents differing depending on whether said request is for a temporary use of the tool or for a permanent use of the tool.

7. The server according to claim 4, further comprising a requesting circuit for requesting that a computer of an information producer having transmitted a request for said tool and transmitted no information produced by said information producer by means of said tool should transmit information produced by means of said tool.

8. A server for providing information via a network connected to a computer of an information producer and a computer of an information requester, said computer of the information producer transmitting to said server information produced by said information producer by means of a tool implemented in said computer of the information producer,
said server comprising:
receiving means connected to said network for receiving from said computer of the information producer said information produced by means of said tool;
storing means connected to said receiving means for storing said information received by said receiving means;
request receiving means connected to said network for receiving from said computer of the information requester a request for said information;
transmitting means connected to said storing means and said request receiving means for transmitting to said computer of the information requester, in response to reception of said request from said computer of the information requester, the information stored in said storing means and advertising information for outputting on said computer of the information requester an advertisement of an advertiser of the tool used for producing said information; and
calculating means for calculating an advertising rate to be collected from said advertiser based on the number of information producers using said tool and calculating an information providing fee to be paid to said information producer based on the calculated advertising rate and the number of information requesters requesting said information.

9. The server according to claim 8, further comprising:
demonstration storing means for storing tool demonstration information used for performing a demonstration of said tool in said computer of the information producer;
demonstration request receiving means for receiving a request for the demonstration from said information producer; and
demonstration transmitting means connected to said demonstration storing means and said demonstration request receiving means for transmitting said tool demonstration information to said computer of the information producer in response to reception of said request for the demonstration from said information producer.

10. The server according to claim 8, wherein
said server is used in an online educational system for education via the network,
said information producer is a lecturer in said online educational system,
said information requester is a student in said online educational system, and
said information is lecture data.

11. The server according to claim 8, further comprising:
tool storing means for storing tool implementation information used for implementing said tool in said computer of the information producer;
tool request receiving means for receiving a request for said tool from said computer of the information producer; and
tool transmitting means connected to said tool storing means and said tool request receiving means for transmitting said tool implementation information to said computer of the information producer in response to reception of said request for the tool from said computer of the information producer.

12. The server according to claim 11, wherein
said request for the tool is made in two types, one is a request for a temporary use of said tool and the other is a request for a permanent use of said tool, and
said calculating means includes means for calculating said advertising rate differing depending on whether said request is for a temporary use of the tool or for a permanent use of the tool.

13. The server according to claim 11, wherein
said request for the tool is made in two types, one is a request for a temporary use of said tool and the other is a request for a permanent use of said tool, and
said transmitting means includes means for transmitting to said computer of the information requester said advertising information having contents differing depending on whether said request is for a temporary use of the tool or for a permanent use of the tool.

14. The server according to claim 11, further comprising requesting means for requesting that a computer of an information producer having transmitted a request for said tool and transmitted no information produced by said information producer by means of said tool should transmit information produced by means of said tool.

15. An information providing method employed by a server for providing information via a network connected to a computer of an information producer and a computer of an information requester, said computer of the information producer transmitting to said server information produced by said information producer by means of a tool implemented in said computer of the information producer,
said information providing method comprising the steps of:
receiving from said computer of the information producer said information produced by means of said tool;
storing said information received in said information receiving step;
receiving a request for said information from said computer of the information requester;
transmitting to said computer of the information requester, in response to reception of said request from said computer of the information requester, the information stored in said storing step and advertising information for outputting on said computer of the information requester an advertisement of an advertiser of the tool used for producing said information; and
calculating an advertising rate to be collected from said advertiser based on the number of information producers using said tool and calculating an information providing fee to be paid to said information producer based on the calculated advertising rate and the number of information requesters requesting said information.

16. The information providing method according to claim 15, further comprising the steps of:
preparing tool demonstration information used for performing a demonstration of said tool in said computer of the information producer;
receiving a request for the demonstration from said information producer; and
transmitting said tool demonstration information to said computer of the information producer in response to reception of said request for the demonstration from said information producer.

17. The information providing method according to claim 15, wherein
said information providing method is employed by the server used in an online educational system for education via the network,
said information producer is a lecturer in said online educational system,
said information requester is a student in said online educational system, and
said information is lecture data.

18. The information providing method according to claim 15, further comprising the steps of:
preparing tool implementation information used for implementing said tool in said computer of the information producer;
receiving a request for said tool from said computer of the information producer; and
transmitting said tool implementation information to said computer of the information producer in response to reception of said request for the tool from said computer of the information producer.

19. The information providing method according to claim 18, wherein
said request for the tool is made in two types, one is a request for a temporary use of said tool and the other is a request for a permanent use of said tool, and
said step of calculating the information providing fee includes the step of calculating said advertising rate differing depending on whether said request is for a temporary use of the tool or for a permanent use of the tool.

20. The information providing method according to claim 18, wherein
said request for the tool is made in two types, one is a request for a temporary use of said tool and the other is a request for a permanent use of said tool, and
said step of transmitting said information and said advertising information includes the step of transmitting to said computer of the information requester said advertising information having contents differing depending on whether said request is for a temporary use of the tool or for a permanent use of the tool.
